(19) United States
(12) Patent Application Publication
(10) Pub. No.: US 2011/0077022 A1
(43) Pub. Date: Mar. 31, 2011

(54) Carrier based in-network location triggered managed processing of wireless communications

(76) Inventor: Kim Robert Scovill, Newark, DE (US)

(21) Appl. No.: 12/923,478

(22) Filed: Sep. 23, 2010

Related U.S. Application Data
(60) Provisional application No. 61/272,419, filed on Sep. 23, 2009.

(51) Int. Cl. H04W 24/00

(52) U.S. Cl. 455/456.1

(57) ABSTRACT

An in-network wireless device call/message management system and method. The system comprises a wireless network, a controlled region served by the wireless network, a location service platform to ascertain location of wireless devices in the controlled region, a database memory to store call/message permission status of certain of the wireless devices in the controlled region, and a call/message manager to monitor incoming/outgoing calls and/or messages of certain of said wireless devices where the manager effects implementation of call privileges according to the permission status and location of managed wireless device within the controlled region.

The present application claims priority from U.S. Provisional No. 61/272,419, filed Sep. 23, 2009, entitled “Automatic SMS and/or Call Suspension System and Method for Mobile Devices in Motion,” to Scovill, the entirety of which is explicitly incorporated herein by reference.

### BACKGROUND OF THE INVENTION

1. Field of the Invention

This invention relates to wireless communications. More specifically it relates to an in-network management system and method to control call privileges of persons using wireless devices located within a secure, restricted, or controlled region.

2. Background of the Related Art

The use of wireless devices in certain institutions is legally and sometimes preferably restricted. For instance, particularly in corrections institutions, the use of cell phones by visitors and other non-inmates is restricted. Similarly, when on a flying airplane cell phone use is restricted. Other situations such as in movie theatres, classrooms and the like, restrict use of certain features of a wireless device.

Restriction of the use of cell phones in corrections institutions and other restricted areas has previously been addressed by interjecting a third party device to control calls, but these devices are able to operate outside of a given carrier's network, therefore possibly leaving those particular wireless devices unmonitored and/or not intercepted or otherwise restricted from use by a different carrier.

Other existing solutions generally provide all-or-nothing techniques such as blocking or interception of all calls and of all wireless frequencies in a particular geographic area without regard to the type of call, the subscriber, calling wireless device, etc.

Examples of existing systems include those commercially available from: ITT/Cell Hound (detection), Page II Science (detection), Air Patrol/Microtech (detection), TCor (managed access), CompuCat (detection), Nortel Government Solutions (detection), and Cell Antenna.

However, such prior art systems have limitations and drawbacks recognized by the present inventor. For instance, third-party out-of-network systems and devices operate primarily independently of an underlying network, and thus restriction of the use of such devices cannot be guaranteed. Moreover, as an out of network device or system, the prior art devices require installation in or very near the secure facility being controlled, resulting in a difficult and expensive installation, devices that possibly are subject to tampering, and/or devices that can be improperly deactivated—thus creating even more expense to repair.

Other limitations result from the fact that the wireless spectrum is not pure, and gross blocking of radio frequency (RF) spectrum in a particular frequency range used by relevant wireless devices has inherent problems because wireless devices and callers outside of the specified geographic area may also be affected by imprecise geography of the physical region. Gross blockage of a given RF frequency in any given geographical area also does mot enable distinction between legitimate emergency calls and improper calls within the target restricted area or facility.

Furthermore, current wireless device-restricting technologies, both the blocking type and the intercepting type, require placement of sensors close to or in the controlled or restricted area. But these type devices are vulnerable to tampering or destruction, again significantly raising the cost of such a system.

The present inventor has also realized that any non-embedded wireless device restricting system frequently requires personnel and/or resources at the subject institution to operate and maintain the blocking or detection system, this too adding extra expense and distraction.

It is also realized by the inventor herein that prior art standalone systems typically have little redundancy, and/or power supply stability (e.g., batteries), and therefore may lack the specific minimum measured reliability that such a network based technology often is required to have in certain applications (e.g., in a corrections institution) either by law or regulation. Some prior art standalone systems also require a separate installation in each controlled facility.

There is a need for an improved method and apparatus to restrict features and use of WCDs within given restricted areas, e.g., within corrections institutions, restricted-use buildings or compounds, or other defined geographic area.

### SUMMARY OF THE INVENTION

In accordance with the principles of the present invention, a network-based wireless device restricted communication manager comprises a defined restricted region served by a wireless network. A network server obtains a current location of a called wireless device serviced by the wireless network. A location triggered restricted communication manager triggers to cause restriction of at least one wireless feature of the called wireless device if the called wireless device is within the restricted region.

In accordance with another aspect of the invention, a network-based wireless device restricted communication manager comprises a defined restricted region served by a wireless network. A network server obtains a current location of a transmitting wireless device serviced by the wireless network. A location triggered restricted communication manager triggers to cause restriction of at least one wireless feature of the transmitting wireless device if the transmitting wireless device is within the restricted region.

In accordance with yet another aspect of the invention, a network-based wireless device restricted communication manager comprises a defined restricted region served by a wireless network. A network server obtains a current location of a texted wireless device serviced by the wireless network. A location triggered restricted communication manager triggers to cause restriction of at least a text messaging capability of the texted wireless device if the texted wireless device is within the restricted region.

In accordance with still another aspect of the invention, a method of restricting wireless device operation when within a restricted area, comprises obtaining a current location of a called or texted wireless device serviced by a wireless network (or via switched network, WiFi, broadband network, or satellite network). The current location of the called or texted wireless device is compared to a restricted area. Delivery of a call placed or text message addressed to the called or texted wireless device is restricted if the called or texted wireless device is within the restricted area.

### BRIEF DESCRIPTION OF THE DRAWINGS

Features and advantages of the present invention will become apparent to those skilled in the art from the following description with reference to the drawings:

FIG. 1 shows a voice and messaging network including an in-network, location-triggered wireless device management system according to the present invention.

FIG. 2 illustrates a method that may be implemented in the network of FIG. 1.

### DETAILED DESCRIPTION OF ILLUSTRATIVE EMBODIMENTS

The presence and use of cell phones, text messaging, satellite, WiFi, or broadband IP communications from inside a corrections facility enable direct and unsupervised communications that may be used, among other things, to circumvent correction facility rules, and at worst, to promote and/or commit further crimes. As such, the use of cell and other types of wireless communications devices (WCDs) is typically restricted in such an environment. The challenge is in how that restriction is accomplished.

The simplest solution is to prohibit WCDs altogether in such an environment. A next simplest solution, currently implemented on most airlines, is to require that all wireless devices within the restricted area (e.g., on the plane) be turned off. But even in these simple scenarios, the restriction of use of a WCD can be circumvented by a nefarious user, or even an unintentional user.

Short of these simpler solutions, there is a need to restrict the use of functioning WCDs that are present within a given restricted area. This is particularly the case where it is desirous to allow certain use of a WCD in an otherwise restricted physical geographic area, e.g., to allow 911 emergency use of WCDs even in a restricted area.

The present invention, in one application thereof, solves problems faced in restricting use of wireless devices in certain geographic locations. For example, many local, state, and federal corrections institutions require restriction of the use of WCDs inside corrections facilities. The present invention provides a system and method to essentially guarantee restriction of illegal or otherwise improper use of wireless devices by visitors, inmates, and others when located within a restricted area, e.g., when inside the confines of a corrections facility.

In accordance with the present invention, switched calls, Voice Over Internet Protocol (VoIP) calls, text messages, instant-messages, emails or other packet based RF transmissions from restricted wireless devices are monitored and selectively blocked (thus intercepted) via control by the network based on the particular location of the sender as it relates to a given restricted area. In one embodiment, intercepted calls, text messages, instant-messages, emails or other packet based transmissions are preferably routed to an intercepting server for re-routed processing. For instance, when an intercepted call is determined to be subject to restriction based on the location of the caller or texter (or called or texted party), the carrier may elect to notify the caller of such restriction as it blocks the call or text. Or as an alternative, particularly in the scenario of a corrections institute, the call may be monitored without notification to the caller, texter, called or texted party.

Restricted devices may be permitted to operate certain features even in a designated restricted geographic area. For instance, certain features such as a call or text to 911 may be permitted to proceed normally regardless of the location of the wireless device, and regardless of the identity of who the caller is. Thus, certain particular outgoing (or incoming) calls (e.g., emergency or other 911 calls) may always be permitted to go through without interception or other interference and/or monitoring. The identity of the caller, texter, called, or texted may be determined, e.g., based on source URL, telephone number or serial number.

The present invention provides a network based system that advantageously has the capability to serve many locations simultaneously as it is server-based and network-located.

The present invention is device independent, and may be linked with other technologies, such as security cameras or alarms. For instance, the present invention overcomes limitations and drawbacks of prior and current devices and systems, e.g., those systems that are device or spectrum dependent, by intercepting a particularly-addressed data stream, preferably after reception by a relevant radio tower, intended for call processing, text message processing, emailing, etc., based on a location of the sender of such call, text message, instant-message, email, etc.

The location of the sender of the monitored and potentially intercepted call, text message, instant-message, email, etc., is preferably obtained via a positioning server in the wireless network. Location may alternatively be obtained from the monitored wireless itself.

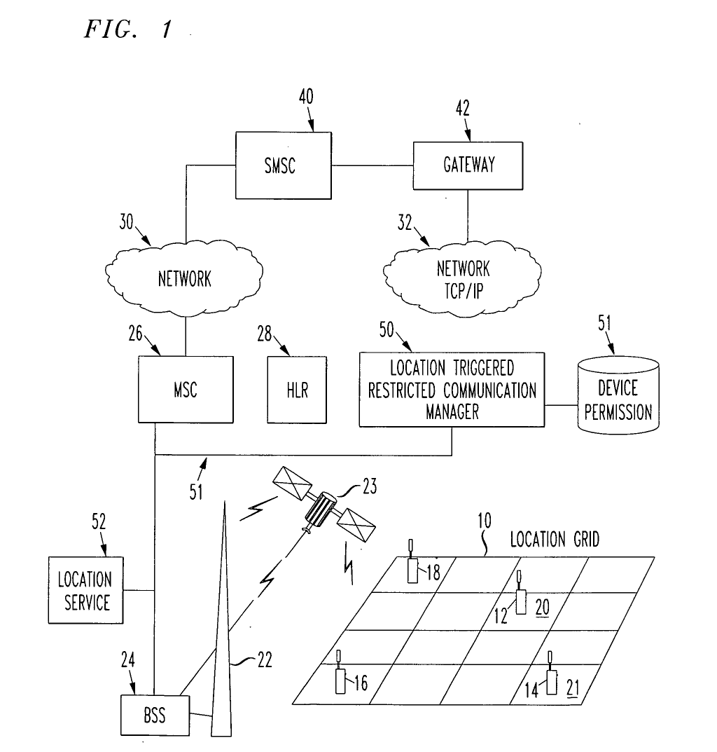

FIG. 1 illustrates an embodiment of a location-centric triggered in-network wireless voice/messaging communication-managed routing and/or interception system to manage and/or control access and communication privileges of wireless devices located within a defined geographic area, in accordance with the principles of the present invention.

In particular, as shown in FIG. 1, wireless devices 12 and 14 are located within regions 20, 21 respectively, of a location grid 10. The location grid 10 is symbolic of a two-dimensional geographic region served by a wireless communication service provider and spans an area that encompasses one or more institutions, grounds, building facilities, campuses, or other regions or structures within which wireless communication is to be restricted, e.g., managed, controlled, intercepted, limited, blocked, or otherwise restricted. Such regions or structures may include prisons, secure areas, secret facilities, or other institutions.

While shown within a two-dimensional location grid, the invention is also applicable in a location-based system capable of accurately determining altitude to 3 dimensional restricted areas and restriction of wireless device use therein. For instance, in an office or other multi-floor building where restriction is desired for just a certain floor(s) of the building, certain office spaces, etc. Moreover, while shown in a squared grid, the invention is equally applicable to geographic regions of any shape or size.

Wireless devices 12, 14, 16, 18 may be, for example, cell phones, PDAs, laptops, satellite phones, and other wireless devices operated within the location grid 10 in communication with a given wireless network, e.g., via one or more cell towers 22, or a satellite 23. The network of FIG. 1 may include a plurality of communications towers and/or satellites and associated communication devices and equipment serving a given region, and/or multiple regions may be served by a single tower 22 or satellite 23. Regions 20, 21 may, for example, encompass the geographic area of a prison facility or other physical facility in which wireless communications are in some way restricted. In a conventional wireless communication system, a base station system 24 couples transmission tower 22 to convey subscriber signals of wireless devices 12, 14, 16, 18 to and from a mobile switching center 26 in accordance with subscriber information contained in a suitable home location register 28. Although only one MSC 26 is shown, multiple mobile switching centers handling other wireless devices may intercommunicate through the wireless network (e.g., SS7, TCP/IP, etc.) 30.

Subscriber calls may be routed to a remote device (not shown) (e.g., another WCD) in communication with a remote mobile switching center through a carrier's wireless network 30. In addition, the wireless network 30 may include a short message service center 40 to convey SMS messages between and among wireless devices. Multiple SMSCs may intercommunicate with each other through one or more suitable gateway(s) 42 via a TCP/IP network 32 (e.g., the Internet) as is otherwise known in the art.

TCP/IP-based subscriber communication devices may access the TCP/IP network 32 via a gateway 34. A remote device may be adapted to initiate a call to or receive calls from wireless devices 12 and 14 in accordance with a similar process. In accordance with the present invention, conveyance of short messages or other types of communications with wireless devices 12 and 14 may also be restricted by being managed, controlled, limited, blocked, or otherwise restricted.

In the illustrated embodiment of the invention, a location-triggered restricted communication manager 50 controls, intercepts, manages, limits, or otherwise restricts calls or messages to and/or from the relevant wireless devices 12 and 14 according to the actual location of the wireless devices 12, 14, and optionally based on a permission status for any given phone. For instance, a supervisor with a properly identified wireless device may be permitted full use of all features of that particular wireless device, while unidentified, unidentifiable, or other wireless devices subject to the restrictions in place for that given geographic region may be blocked, managed, or otherwise restricted from use of some or all features.

While disclosed features that are restricted are presumed to utilize wireless communications (e.g., SMS, phone call, browsing the Internet, etc.), the invention may be used to restrict non-wireless features (e.g., a video game, book reader, etc.)

The identity and associated permission status of any authorized wireless device 12 and 14 may be stored in a database or memory accessible to the wireless network 30.

Location is obtained for any RF communication sensed at a given cell tower 22 or satellite 23 that receives communications from a given restricted facility. A suitable location service platform 52 may be used for the wireless network 30 to obtain the location of any wireless device 12, 14, 16, 18 within the service area of a responsible radio tower 22. Location-based services may employ GPS, time-of-arrival measurements, signal strength measurements, or other methods known in the art. The control status and/or permissions afforded all wireless devices 12-18 within location grid 10 may be discriminated or determined based on detected location information.

Permission status afforded each wireless device 12, 14 may reside in a database memory, which may comprise part of the location triggered restricted communication manager 50. The database may include, for example, data records in memory associated with each wireless device 12, 14 authorized for at least some use in a given restricted area, along with call privileges, and/or restrictions assigned to that wireless device 12, 14.

In the given example of FIG. 1, wireless device 16 and 18, are currently outside restricted regions 20, 21 and therefore remain uncontrolled so that communication initiated or received by these devices proceeds in a normal, unimpeded fashion.

The location triggered restricted communication manager 50 may monitor the wireless network over a suitable link 51 for outgoing/incoming calls, messages, or other transmission types subject to restriction.

Communications over the link 51 between the location triggered restricted communication manager 50 and the base station 24, MSC 26 or other element in the wireless network may proceed under a suitable messaging protocol, e.g., SS7, TCP/IP, or other protocol.

The location triggered restricted communication manager 50 may comprise a software module embedded within or with a server providing MSC functionality. In addition, rather than using the link 51, the location-triggered restricted communication manager 50 may intercept calls and messages of relevant unauthorized wireless devices 12, 14 at one or more other locations in the wireless network, or remotely as a third party server platform. Thus, a server providing location triggered communication management may be interjected into the wireless network at any suitably desired location to capture supervised calls or messaging of wireless devices 12, 14, e.g., within the BSS 24, within the MSC 26, between the MAC 26 and wireless network 30, etc.

Given the location of a receiver of a given call going into or the location of a sending wireless device located itself in a restricted region 20, 21, the location triggered restricted communication manager may apply a desired amount of management to the call, message, or text. The management may result in monitoring of the call or text (secret or announced), or it may result in blockage altogether.

The location triggered restricted communication manager 50 may review the phone number, URL, MIN, or other identification of the wireless device located in the restricted region 20, 21, and thus subject to restriction, and perform a lookup in a suitable database to determine a permission status for that particular wireless device. If the identity either cannot be determined, or if it is otherwise unknown, a default level of restriction may be imposed, e.g., total blockage of communication. The wireless network may be configured to announce the imposition of restriction to the restricted wireless device, and/or it may be reported to a supervisor, and/or it may be left unannounced altogether.

The location triggered restricted communication manager 50 may be configured to always permit certain wireless communications or other features. For instance, emergency 911 calls may be permitted to proceed unrestricted by any/all wireless devices even if located within a restricted region 20, 21 and even if the wireless device 12, 14 is unidentified.

The location triggered restricted communication manager 50 may also detect a wireless device within a restricted region 20, 21, and attempt to identify the wireless device 12, 14 to determine if the wireless device 12, 14 is authorized for any operation within the restricted area 20, 21, and determine if the requested operation (e.g., sending a text message, making a call, etc.) may be permitted to connect to the wireless network 30.

The location triggered restricted communication manager 50 preferably has access to a device permission database 51 associating identities of a plurality of wireless devices with certain operations that are permitted within any given restricted area. The permitted operations may include any/all desired feature permissions, e.g., “ALL”, “911”, “text messaging”, “phone call”, “Internet browsing”, “Instant Messages”, and any combination thereof, etc. Upon an indication that a given wireless device 12, 14 has been located within a restricted region 20, 21 (e.g., within the walls of a corrections institute), the location triggered restricted communication manager 50 determines whether or not a particular requested operation by or for that wireless device 12, 14 should be permitted to proceed.

The location triggered restricted communication manager 50 may exercise control based on a latitude/longitude (lat/lon) location obtained relevant to a wireless device 12, 14 being within the coordinates of a restricted region 20, 21. In each instance, the location triggered restricted communication manager 50 affects the appropriate controls within the MSC 26 to result in restriction of a functionality of the restricted wireless device 12, 14, e.g., to allow, block, or otherwise limit a call received or initiated by that wireless device 12, 14, while that wireless device 12, 14 continues to remain located within a relevant restricted region 20, 21. The location triggered restricted communication manager 50 may also initiate other action based on particularities of call parameters detected for the restricted wireless device 12, 14, such as to cause the activation of security cameras in the given region 20, 21; to monitor the call, chat, text messaging, instant-message, etc.; to intercept the call, text message, etc. and place it in communication with a supervising authority; or to simply alert guards or other personnel about the call or message activity.

Software or hardware modules within the location triggered restricted communication manager 50 are operative to compare the detected location of the messaging device(s) 12, 14 against pre-determined geographic parameters that define a subject geographic area (or areas) 20, 21, e.g., defining the walls of a secure building. The location triggered restricted communication manager 50 may permit a wireless device calling from outside the subject calling area 20 to proceed with its call or message TO a wireless device 12, 14 located within a restricted area 20, 21 in a normal manner—but only if the permissions of the called wireless device 12, 14 because it is that called wireless device 12, 14 that is within the restricted area 20, 21.

The location triggered restricted communication manager 50 may stop the processing of a call and/or return a message to a caller that the call has been blocked, terminated, or otherwise restricted. Any desired message or notification concerning the call may be sent to the call initiator, the call recipient, or to a third party—or to neither party to the wireless device activity.

The location triggered restricted communication manager 50 may permit a call, text, etc. to proceed to or from a wireless device 12, 14 inside a restricted region 20, 21, but may use the identity (or non-identity) of the wireless device 12, 14 within the restricted region 20, 21 to trigger for further action by the wireless network 30 (under the control of the location triggered restricted communication manager 50), e.g., by sending the identity of the wireless device 12, 14 within the restricted region 20, 21 to another application for display or processing, or to signal the activation of other equipment. For instance, devices such as surveillance cameras may be triggered to make an optical record of the relevant restricted region 20, 21 that is being violated. Or a lawfully permitted interrogation and/or recording of the content of the attempted call, message, etc. may be initiated.

The location triggered restricted communication manager 50 may log or otherwise track the individual wireless events within a restricted region 20, 21. For instance, relevant features of an attempted wireless call may be recorded, e.g., call sequence, success or failure, time, duration, interaction with other events, and/or other relevant criteria for use in the operation and/or record keeping of wireless activity.

Links interconnecting the functional elements of FIG. 1 are symbolic of standard communication protocols implemented in the industry. For example, communication between base station system 22 mobile switching center 26 and/or a satellite 23 proceeds under SS7 protocols while communication between the SMSC 40 and network 32 proceeds under a TCP/IP protocol.

Another aspect of the invention comprises a method of in-network monitoring or managing a permission rights for calls and messages originating or terminating in a specified region. For incoming and/or outgoing calls and/or messages, the method comprises

providing a wireless communications network containing one or more communications towers or satellites;

monitoring the network for outgoing/incoming calls and messages on a defined collection/determined array of such communications towers or satellites;

when a call or message is initiated or received, for outgoing calls or messages, (a) reviewing the identity of the called or addressed party using a destination number/address to determine if it is a type of call or message that should always be permitted and processed in a particular way (e.g., a “911” call), (b) reviewing or detecting the identification number and/or phone number of the wireless device to determine if the call or message should be permitted to connect to the network, and obtaining the current location of the device initiating and the device receiving the call or message;

comparing the location of the messaging device(s) against pre-determined geographic parameters that define a subject calling area (or areas);

permitting a device calling from outside the subject calling area to proceed with its call or message only if the receiving party is not in a restricted region or area defined by a given lat/lon region;

blocking or otherwise restricting the processing of a call and/or message to or from a calling device currently located within a restricted region defined by a given lat/lon range defining a perimeter of the restricted area. Alternatively the call or message can be permitted to proceed but with approved monitoring by appropriate enforcement personnel. Or the call or message may be routed to another application for display or processing. Or the restriction may be in the form of simultaneous operation, e.g., the activation of surveillance cameras. Or the restriction imposed may relate to the activation of real time, lawful recording, and/or interrogation of the content of the restricted call and/or message.

The restricted call and/or message may be logged or otherwise tracked, as well as any details relating to the call or message such as its sequence, success or failure, time, duration, interaction with other events, and other relevant criteria for use in the operation and/or record keeping.

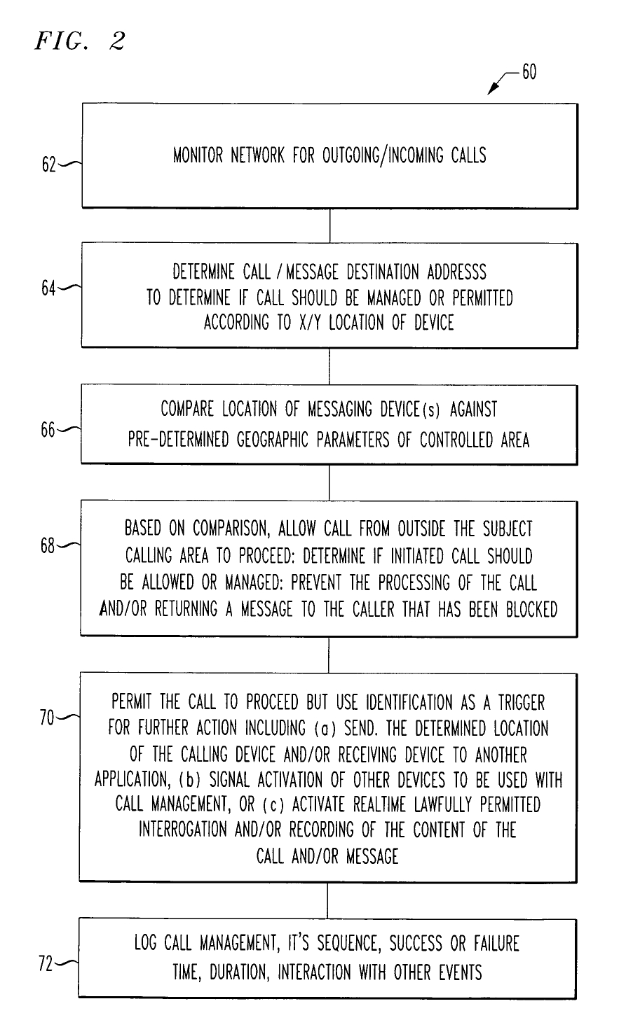

FIG. 2 exemplifies a method of providing location-centric triggered in-network wireless voice/messaging communication-managed routing and/or interception to manage and/or control access and communication privileges of wireless devices located within a defined geographic area, in accordance with the principles of the present invention.

In particular, as shown in FIG. 2, the exemplary method 60 comprises a step 62 of monitoring a network for outgoing or incoming calls or messages.

In step 64, the destination phone number and/or the destination address of a monitored call is obtained to determine if that call should be managed or permitted according to an X/Y lat/lon current location of the calling or called device. It is preferred that this feature be non-configurable by the user of the wireless device to avoid the ability to avoid monitoring.

In step 66, the location of the called and calling wireless devices are compared against pre-determined geographic parameters defining restricted area(s).

In step 68, based on the results of the comparison, if the calling and called wireless devices are both not within a restricted area, the call or message is allowed to proceed unencumbered. If, on the other hand, either the calling party or the called party is currently within a region defined as being restricted, the call is restricted in accordance with the desires of the particular restricting party. For instance, the call or message may be stopped, blocked or otherwise restricted or monitored.

In step 70, the call is permitted to proceed but is monitored or triggers other restriction-related action, e.g., (a) sending the determined location of the calling device and/or receiving device to another application, (b) signaling activation of another device to be used with management of the restricted call, or (c) activating real time lawfully permitted interrogation and/or recording of the content of the call and/or message.

In step 72, call management parameters relating to the restricted call are logged. Possible parameters include phone number, address or other identity, call sequence, its success or failure, the location of the caller and called party, the time of the call, the duration of the call, etc.

The in-network location triggered restricted communication manager 50 and the method thereof offer significant security, financial, flexibility, upgradability, control, and operational advantages over prior solutions, or solutions that do not encompass a full spectrum of restrictive treatments of a call or message. In addition to real time location-dependent call management, the operation of the location triggered restricted communication manager 50 may be tailored to provide solutions from blocking to CALEA-sanctioned (“Commission on Accreditation for Law Enforcement Agencies”) wiretapping for legitimate use of law enforcement in the effort to prevent new or to prosecute ongoing alleged criminal activities.

Likely users of the invention include local, state, and federal correction authorities and law enforcement institutions, and commercial organizations that have similar security needs. Services in accordance with the present invention may be provided by the wireless network providers so the class of customers may also be expanded to other institutions and organizations that need routing and/or monitoring services on a temporary or permanent basis.

The invention includes software modules and hardware elements operating in conjunction with the provider's call messaging systems in, associated with, or in connection with a carrier's network that for incoming and/or outgoing calls and/or messages,

While the invention has been described with reference to the exemplary embodiments thereof, those skilled in the art will be able to make various modifications to the described embodiments of the invention without departing from the true spirit and scope of the invention.

What is claimed is:

1. A network-based wireless device restricted communication manager, comprising:
a defined restricted region served by a wireless and/or satellite network;
a network server to obtain a current location of a called wireless device serviced by said wireless network; and
a location triggered restricted communication manager triggered to cause restriction of at least one wireless feature of said called wireless device if said called wireless device is within said restricted region.

2. The network-based wireless device restricted communication manager according to claim 1, wherein said at last one wireless feature comprises:
a wireless device.

3. The network-based wireless device restricted communication manager according to claim 1, wherein said wireless device comprises:
a phone.

4. The network-based wireless device restricted communication manager according to claim 1, wherein said at last one wireless feature comprises:
a text messaging application.

5. The network-based wireless device restricted communication manager according to claim 1, wherein said at last one wireless feature comprises:
power to said wireless device.

6. The network-based wireless device restricted communication manager according to claim 1, wherein:
said restricted region is defined by walls of a restricted building.

7. The network-based wireless device restricted communication manager according to claim 1, wherein:
said restricted region is defined by a perimeter of a corrections institution.

8. The network-based wireless device restricted communication manager according to claim 1, further comprising:
a database to associate a restricted permission status of uniquely identified wireless devices to permitted operation of said at least one feature.

9. A network-based wireless device restricted communication manager, comprising:
a defined restricted region served by a wireless network;
a network server to obtain a current location of a transmitting wireless device serviced by said wireless network; and
a location triggered restricted communication manager triggered to cause restriction of at least one wireless feature of said transmitting wireless device if said transmitting wireless device is within said restricted region.

10. The network-based wireless device restricted communication manager according to claim 9, wherein said at last one wireless feature comprises:
a phone.

11. The network-based wireless device restricted communication manager according to claim 9, wherein said at last one wireless feature comprises:
a text messaging application.

12. The network-based wireless device restricted communication manager according to claim 9, wherein said at last one wireless feature comprises:
power to said wireless device.

13. The network-based wireless device restricted communication manager according to claim 9, wherein:
said restricted region is defined by walls of a restricted building.

14. The network-based wireless device restricted communication manager according to claim 9, wherein:
said restricted region is defined by a perimeter of a corrections institution.

15. The network-based wireless device restricted communication manager according to claim 9, further comprising:
a database to associate a restricted permission status of uniquely identified wireless devices to permitted operation of said at least one feature.

16. The network-based wireless device restricted communication manager according to claim 9, wherein:
said transmitting wireless device is transmitting a text message.

17. The network-based wireless device restricted communication manager according to claim 9, wherein:
said transmitting wireless device is placing a call.

18. A network-based wireless device restricted communication manager, comprising:
a defined restricted region served by a wireless and/or satellite network;
a network server to obtain a current location of a texted wireless device serviced by said wireless network; and
a location triggered restricted communication manager triggered to cause restriction of at least a text messaging capability of said texted wireless device if said texted wireless device is within said restricted region.

19. The network-based wireless device restricted communication manager according to claim 18, wherein:
said restricted region is defined by walls of a restricted building.

20. The network-based wireless device restricted communication manager according to claim 18, wherein:
said restricted region is defined by a perimeter of a corrections institution.

21. The network-based wireless device restricted communication manager according to claim 18, further comprising:
a database to associate a restricted permission status of uniquely identified wireless devices to permitted operation of said text messaging capability.

22. A method of restricting wireless device operation when within a restricted area, comprising:
obtaining a current location of a called wireless device serviced by a wireless network;
comparing said current location of said called wireless device to a restricted area; and
restricting delivery of a call placed to said called wireless device if said called wireless device is within said restricted area.

23. The method of restricting wireless device operation when within a restricted area according to claim 22, wherein said restricting delivery comprises:
blocking delivery of said call placed to said called wireless device.

24. The method of restricting wireless device operation when within a restricted area according to claim 22, wherein said restricting delivery comprises:
logging at least one parameter of said call.

25. The method of restricting wireless device operation when within a restricted area according to claim 22, wherein said restricting delivery comprises:
monitoring content of said call.

26. The method of restricting wireless device operation when within a restricted area according to claim 22, wherein said restricting delivery comprises:
recording said call.

27. The method of restricting wireless device operation when within a restricted area according to claim 22, wherein:
said restricted area is defined by a perimeter.

28. The method of restricting wireless device operation when within a restricted area according to claim 22, wherein:
said restricted area is defined by a building.

29. A method of restricting wireless device operation when within a restricted area, comprising:
obtaining a current location of a texted wireless device serviced by a wireless network, WiFi, broadband network, or satellite network;
comparing said current location of said called wireless device to a restricted area; and
restricting delivery of a text message addressed to said called wireless device if said texted wireless device is within said restricted area.

30. The method of restricting wireless device operation when within a restricted area according to claim 29, wherein said restricting delivery comprises:
blocking delivery of said text message addressed to said texted wireless device.

31. The method of restricting wireless device operation when within a restricted area according to claim 29, wherein said restricting delivery comprises:
logging said text message.

32. The method of restricting wireless device operation when within a restricted area according to claim 29, wherein:
said restricted area is defined by a perimeter.

33. The method of restricting wireless device operation when within a restricted area according to claim 29, wherein:
said restricted area is defined by a building.
